(19) United States
(12) Patent Application Publication
(10) Pub. No.: US 2015/0140199 A1
(43) Pub. Date: May 21, 2015

(54) METHOD AND DEVICE FOR THE AUTOMATED APPLICATION OF A SPRAY COATING

(71) Applicant: SIEMENS AKTIENGESELLSCHAFT, Munchen (DE)

(72) Inventors: Andy BORCHARDT, Berlin (DE); Tobias BRETT, Schonefeld (DE); Karsten KLEIN, Berlin (DE); Khaled MAIZ, Berlin (DE); Catrina MICHEL, Birkenwerder (DE); Alexandr SADOVOY, Berlin (DE); Martin WITZEL, Birkenwerder (DE)

(21) Appl. No.: 14/548,738

(22) Filed: Nov. 20, 2014

(30) Foreign Application Priority Data
Nov. 20, 2013 (DE) 102013223688.3

(51) Int. Cl. B05B 12/02; B05D 1/02

(52) U.S. Cl. CPC B05B 12/02; B05D 1/02
USPC 427/8; 118/697

(57) ABSTRACT

A monitoring device (14) and a method for monitoring spray coating of a component by a spraying device (1) including a spray nozzle (3) movable along a specific path in relation to a component surface to be coated. The device has: an input interface (15) for inputting geometry data representative of the geometry of the component surface; a path data recording device (17) for time-resolved recording of path data of the spray nozzle (3) in relation to the component surface; a process data recording device (19) for time-resolved recording of process data of the coating process using the spray nozzle (3); a simulation unit (21) connected to the input interface (15) for receiving the data, for simulating application of the spray coating to the component surface on the basis of the data recorded; and a deviation calculation unit (23), connected to the simulation unit (21), for receiving simulation data and calculating a deviation of the simulated coating from the desired coating.

### CROSS-REFERENCE TO RELATED APPLICATIONS

The present application claims priority of German Patent Application No. 102013223688.3, filed Nov. 20, 2013, the contents of which are incorporated by reference herein.

### TECHNICAL FIELD

The present invention relates to a coating method for the automated application of a spray coating to a component surface to be coated of a component. The component may be in particular a turbine component, such as a turbine blade. In addition, the present invention relates to a coating device for the automated application of a spray coating to a component surface to be coated.

### TECHNICAL BACKGROUND

For example, when coating turbine components, in particular turbine blades, with adhesion-promoting, thermal-barrier and/or oxidation- and corrosion-inhibiting layers by means of spraying methods, stochastic process deviations may occur during the coating. These include, inter alia, changes of the form and size of the spraying spot on account of wearing of the electrode in the spraying device, fluctuations in the powder supply, system failures, etc. Ultimately, significant changes have in the past always led to abnormal termination of the process or to a sub-standard performance, i.e. the coated component had to be stripped of its coating and subsequently re-coated again, or the coated component showed deviations from the specifications or even had to be scrapped.

### SUMMARY OF THE INVENTION

One object of the present invention is to provide an advantageous method and an advantageous device for the automated application of a spray coating to a component surface to be coated that make it possible to respond rapidly to deviations from the desired coating. Another object is to provide an advantageous monitoring device for monitoring the automated application of a spray coating.

The coating method according to the invention for the automated application of a spray coating to a component surface comprises the steps of:

a) Coating the component surface using a spraying process, wherein a spray nozzle is moved along a specific path in relation to the component surface during the coating.

b) Recording in a time-resolved form the path data of the spray nozzle in relation to the component surface to be coated.

c) Recording in a time-resolved form the process data of the coating process, for instance the process parameters, and/or process control data. The process data recorded may in this case be recorded in relation to the component surface or be coupled to the path data recorded. In this way, there is either a direct assignment of the process data recorded at a specific point in time to a specific location of the component surface or an indirect assignment in that the process data recorded at a specific point in time are assigned to a location on the component surface to be coated by way of the path data recorded at the same point in time.

d) Simulating the spraying process on the basis of the path data recorded, the process data recorded and the geometry of the component surface to be coated, in order to obtain a simulated coating. Here, the simulated coating need not be a complete coating. It is sufficient each time when simulating the coating to simulate the coating up to the degree of completion at the time of the actual coating, for example when the simulation takes place in parallel with the spraying process.

e) Calculating a deviation of the simulated coating from a desired coating, in particular with respect to the thickness of the layer and/or the quality of the layer, which may for example be reflected in its porosity.

The simulation of the coating on the basis of the path data recorded and process data recorded makes it possible to rapidly determine a deviation of the actual coating from the desired coating, which in turn makes it possible to rapidly perform corrections to the coating, in particular in an automated way. An automated correction of the coating on the component surface may take place in particular whenever the calculation of the deviation produces a deviation of the simulated coating from the desired coating that exceeds a permissible deviation. If the calculation of the deviation takes place during or directly after the spraying process, a possible correction can be performed even before the turbine blade is removed from the coating machine. In this way, renewed clamping of the turbine blade in the coating machine is not necessary, which ensures that the orientation of the turbine blade during the correction coincides with the orientation during the original spraying process.

In a first variant for correcting the coating, after the end of the spraying process for which the path data and the process data have been recorded in a time-resolved form, a correction coating is applied by a further spraying process. This may take place directly after the application of the original coating having the deviation, so that unclamping and renewed clamping of the blade in the coating machine is not necessary. The path data and the process data for the further spraying process are determined from the deviation of the simulated coating, obtained with the simulated spraying process, from the desired coating.

In a second variant of the correction of the coating, the simulation of the spraying process takes place while carrying out that spraying process in which the path data and the process data are recorded in a time-resolved form. In other words, an online simulation of this spraying process takes place during the original spraying process. Although it is also possible in this case to wait for correction of the coating until the original coating has been completed, the online simulation offers the possibility of correcting the process data of the spraying process at the time by means of correction data. The correction data are in this case determined from the deviation of the simulated coating, obtained with the simulated spraying process, from the desired coating. In this variant of the correction of the coating, the application of the coating and the correction of the coating can take place in the same spraying process. It is advantageous in this case if the correction data are determined within a time period in the range of less than 5 seconds, in particular of less than 1 second and preferably in the range of less than 100 milliseconds, so that a rapid correction is possible, i.e. while the spray nozzle is still in or in the vicinity of the coating region to be corrected.

In a specific development of the invention, updated path data and/or updated process data can be determined on the basis of the deviation of the simulated coating, obtained with the simulated spraying process, from the desired coating and used as a basis for updating the path data and/or the process data for the next spraying process to be carried out for a component with the same geometry of the surface to be coated. In this way, the deviations between the simulated coating and the actual coating that were established in the case of the previously coated component can be avoided, or at least reduced, in the case of the next component.

In another development of the invention, the deviation of the simulated coating, obtained with the simulated spraying process, from the desired coating may be graphically displayed. Such a display may provide an operator with useful information concerning the spraying process carried out. If the graphic display is generated within a time period in the range of less than 5 seconds, in particular less than 1 second and preferably in the range of less than 100 milliseconds, an online monitoring of the spraying process just being carried out can be achieved.

A monitoring device according to the invention for monitoring an automated application of a spray coating to a component surface to be coated, which may in particular be a turbine component, by a spraying device with a spray nozzle, which can be moved along a specific path in relation to the component surface in the course of a spraying process, and with a control unit for controlling the spraying process, comprises:

a) An input interface for inputting geometry data representative of the geometry of the component surface to be coated.

b) A path data recording device for time-resolved recording of the path data of the spray nozzle in relation to the component surface to be coated.

c) A process data recording device for time-resolved recording of the process data of the coating process carried out using the spray nozzle. The process data involved here may be for instance process parameters and/or process control data. The time-resolved recording of the process data may in this case take place in relation to the component surface to be coated in the way explained with reference to the method according to the invention, or the time-resolved process data may be coupled to the time-resolved path data.

d) A simulation unit connected to the input interface for receiving the geometry data, to the path data recording device for receiving the path data recorded in a time-resolved form and to the process data recording device for receiving the process data recorded in a time-resolved form. This unit is designed for simulating the application of the spray coating to the component surface to be coated on the basis of the path data recorded in a time-resolved form, the process data recorded in a time-resolved form and the geometry of the component surface to be coated and keeping it ready for output in the form of simulation data of a simulated coating.

e) A deviation calculation unit, connected to the simulation unit for receiving the simulation data, for calculating a deviation of the simulated coating from the desired coating, for example with respect to the thickness of the layer and/or the quality of the layer, such as for instance the porosity of the layer.

The monitoring device according to the invention together with a spraying device makes it possible to carry out the method according to the invention, and consequently allows the properties and advantages described with reference to the method according to the invention to be realized. Reference is therefore made to the properties and advantages described with reference to the method according to the invention.

In a development of the monitoring device according to the invention, it also comprises a correction data calculation unit, which is connected to the deviation calculation unit for receiving the calculated deviation. The correction data calculation unit calculates correction data for correcting the coating on the component surface to be coated when the calculated deviation exceeds a permissible deviation. The correction data calculation unit therefore makes possible the correction of the applied coating described above in the context of the method according to the invention, in particular when it is part of a coating device that also has a spraying device with a spray nozzle, and the nozzle can be moved along a specific path in relation to the component surface to be coated in the course of a spraying process, and with a control unit for controlling the spraying process. There is the possibility here of correcting the coating while still carrying out the original coating process, i.e. of performing an in-process correction, if the control unit of the spraying device is connected to the correction data calculation unit for receiving the correction data. However, a downstream correction, i.e. a correction after the complete application of the original coating, is also possible with this refinement. Similarly, this refinement makes it possible to revise the path and process data for the application of the coating to the next component to be coated with the same surface geometry of the component surface to be coated.

According to an additional or alternative development, the monitoring device according to the invention may comprise a display unit, which is connected to the deviation calculation unit for receiving the calculated deviation and which generates a display signal for the visual display of the deviation. The visual display can provide an operator with valuable information concerning the coating process. Further features, properties and advantages of the present invention emerge from the following description of exemplary embodiments with reference to the accompanying figures:

### BRIEF DESCRIPTION OF THE DRAWINGS

FIG. 1 shows an exemplary embodiment of a coating device according to the invention in the form of a block diagram.

FIG. 2 shows as an example a gas turbine in a longitudinal partial section.

FIG. 3 shows as an example a movable blade or stationary blade of a turbomachine in a perspective view.

FIG. 4 shows as an example a combustion chamber 110 of a gas turbine.

### DESCRIPTION OF EMBODIMENTS

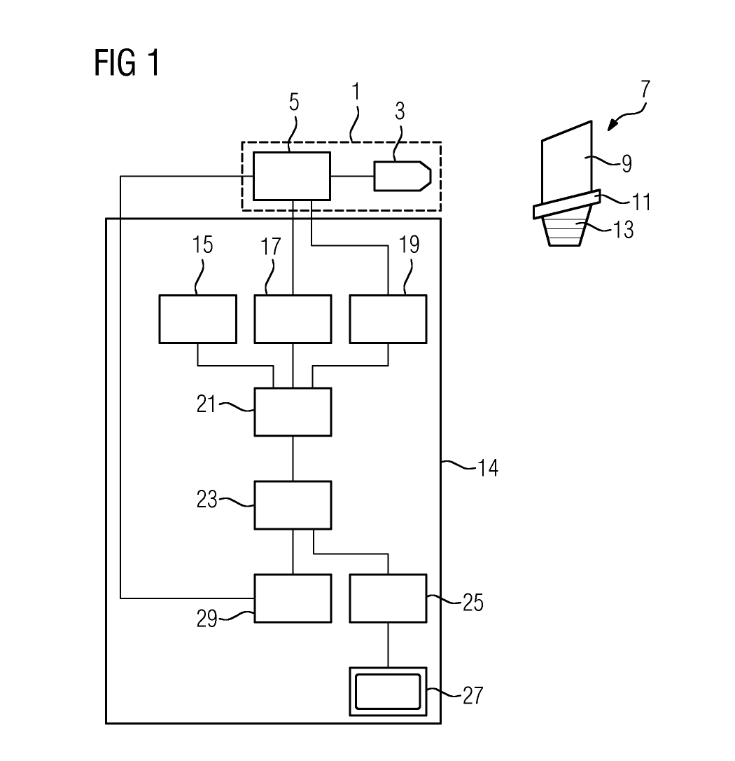

The basic structure of an exemplary embodiment of a coating device according to the invention is described below on the basis of the block diagram with reference to FIG. 1. The coating device of the present exemplary embodiment includes a spraying device 1, which comprises a spray nozzle 3 and a control unit 5. The spray nozzle 3 can be moved in relation to a component surface to be coated to apply a spray coating to the component surface. In the present exemplary embodiment, the component to be coated is a turbine component, specifically a turbine blade 7 which schematically represented in FIG. 1. The turbine blade has a blade airfoil 9, a blade platform 11, adjacent the blade airfoil 9, and a blade root 13, extending from the blade platform. In the case of such a turbine blade, the component surface to be coated generally corresponds to the surface of the blade airfoil 9 and parts of the surface of the blade platform 11. On the other hand, the surface of the blade root and the portions of the surface of the blade platform 11 that are facing the blade root are generally not spray-coated. Although the present invention according to the exemplary embodiment is described on the basis of the spray coating of a turbine blade 7, the invention may also be used in the context of coating surfaces of other components, in particular other turbine components. Examples of other turbine components are combustion chamber linings or burner parts.

To make it possible for the spray nozzle 3 to be moved in relation to the surface of the turbine blade 7 to be coated, the spraying device 1 has kinematics that are not represented in FIG. 1, which may be any suitable kinematics that provide sufficient degrees of freedom to make possible the coating of the surface of the turbine blade 7. For example, a robot arm may be used, in particular one which provides 6 degrees of freedom, to be specific 3 translational degrees of freedom and 3 rotational degrees of freedom.

The control unit 5 of the spraying device 1 controls the path along which the spray nozzle 3 is moved in relation to the surface to be coated during coating of the surface of the turbine blade 7. In addition, the control unit 5 controls the spraying parameters of the spraying process, which may be various parameters depending on the spraying method used. For example, the feed rate at which the spraying powder is supplied and, depending on the spraying method, an applied voltage, a feed rate for fuel gas, etc., may be considered as parameters. Parameters which can be influenced indirectly by the control are for example the kinetic energy with which the sprayed particles impinge on the component surface to be coated, the degree to which the sprayed particles are melted, the particles either not being melted at all, as in the case of cold gas spraying, partially melted or completely melted. Atmospheric plasma spraying (APS), low pressure plasma spraying (LPPS—Low Pressure Plasma Spraying), low vacuum plasma spraying (LVPS—Low Vacuum Plasma Spraying), high velocity flame spraying (HVOF High Velocity Oxygen-Fuel) and comparable thermal spraying methods come into consideration for example as spraying methods.

The coating device according to the invention also comprises a monitoring device according to the invention, with which the spraying process can be monitored. This monitoring device 14 comprises an input interface 15, by way of which geometry data of the surface to be coated can be input into the monitoring device. The geometry data may be obtained for example from a computer-implemented model of the turbine blade 7. Furthermore, the geometry data may also comprise data concerning the position and orientation of the turbine blade 7 or of the component respectively to be coated in the coating device.

Furthermore, the monitoring device comprises a path data recording unit 17 and also a process data recording unit 19. The two units are connected to the control unit 5 of the spraying device 1 and receive from the control unit 5 in a time-resolved form the path data of the spray nozzle 13 in relation to the surface to be coated of the turbine blade 7 or in a time-resolved form the process data that are based on the spraying process. The path data in this case contain both data concerning the position of the spray nozzle and data concerning its orientation, in each case in relation to the component surface to be coated. The time-resolved recording of the process data may in this case be coupled to the time-resolved recording of the path data, so that for any desired point in time a pair is respectively formed from the path data and the associated process data. Since the time-resolved path data are recorded with reference to the component surface to be coated, that is that the position and orientation of the spray nozzle in relation to the surface to be coated are known for each point in time of the recording of path data, and this position and the associated orientation of the spray nozzle are also known for each point in time of the recording of the process data.

On the basis of the time-resolved path data and the time-resolved process data together with the geometry data of the component surface to be coated, a simulation of the spraying process is possible. For this purpose, the monitoring device 14 comprises a simulation unit 21, which is connected to the input interface 15 for receiving the geometry data for the surface to be coated, to the path data recording unit 17 for receiving the time-resolved path data and to the process data recording unit for receiving the time-resolved process data. In the simulation unit, the application of the spray coating to the surface of the turbine blade 7 is simulated on the basis of the geometry of the surface to be coated, the time-resolved path data and the time-resolved process data. The simulation unit keeps the result of the simulation ready for output in the form of simulation data.

Connected to the simulation unit 21 is a deviation calculation unit 23 for receiving the simulation data. The deviation calculation unit 23 calculates on the basis of the simulation data a deviation of the simulated coating from the desired coating. There may be deviations here for example with respect to the thickness of the layer or the quality of the layer. Deviations in the quality of the layer may for example be deviations in the microstructure of the simulated layer from the desired microstructure or deviations in the porosity of the simulated layer from the desired porosity.

Within the scope of the present exemplary embodiment, the determined deviation is output to a display unit 25, which is connected to the deviation calculation unit 23 and generates a display signal, which makes it possible for the deviation to be visually displayed on a monitor 27 or some other suitable display unit. In this way, the operator of the spraying device receives useful information concerning possible risks in the spraying process that is being carried out.

In the present exemplary embodiment, the determined deviation of the simulated coating from the desired coating is additionally output to a correction data calculation unit 29, which is connected to the deviation calculation unit. The correction data calculation unit 29 checks whether the deviation calculated by the deviation calculation unit 23 exceeds a permissible deviation. If this is the case, the correction data calculation unit calculates correction data with which the coating on the component surface can be corrected. By means of these correction data, correction of the original coating can then be performed, for example in a further coating process carried out after the original coating process. The second coating process may in this case be carried out directly after the ending of the first coating process, so that the turbine blade can remain clamped in the coating device. In this way it is ensured that the orientation of the component surface to be coated during the second coating process corresponds to the orientation during the first coating process. As represented in the present exemplary embodiment, the correction data for correcting the coating may be output by the correction data calculation unit directly to the control unit 5 of the spraying device 1, so that an automated correction can take place.

In an alternative refinement of the correction of the coating, the correction takes place while the original coating process is still under way. For this purpose, the simulation of the coating process, the calculation of the deviation of the simulated coating from the desired coating and the calculation of the correction data take place with a brief time delay from the coating process that is in progress. The time delay should as far as possible be less than 5 seconds, in particular less than 1 second and preferably in the range of less than 100 milliseconds, in order to be able as rapidly as possible to bring an effect to bear on the coating process just carried out. In order to make it possible to have such an automated direct influence on the coating process, there are in the control program for the spraying process selected break points in the program sequence, at which the process data and/or the path data of the coating process can be updated. For this purpose, the control program running in the control unit 5 of the spraying device must make it possible for control programs or process and/or path data to be uploaded and downloaded.

A display already during the spraying process is also advantageous in the case of the visual display of the deviations without automated calculation of correction data, since the operator can then stop the spraying process if need be, in order to be able to perform a corrective change or stop an unacceptable coating process at an early time.

Furthermore, the described monitoring of the spraying process makes it possible to adapt the path data and/or the process data for the next spraying process with a identical surface to be coated, in order to reduce or eliminate completely the established deviation of the simulated coating from the desired coating.

Without limitation, the apparatus and method disclosed herein may be performed on any component, including a component of a turbine and particularly a blade thereof.

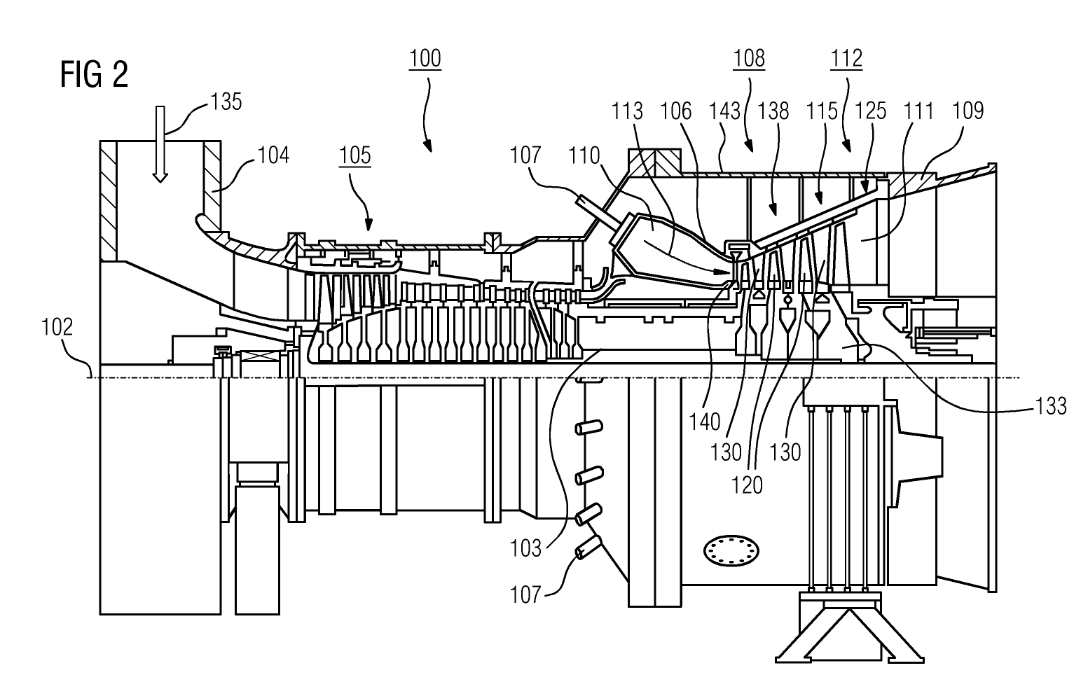

FIG. 2 shows by way of example a gas turbine 100 in a longitudinal partial section.

The gas turbine 100 has in the interior a rotor 103 with a shaft 101, which is rotatably mounted about an axis of rotation 102 and is also referred to as a turbine runner.

Following one another along the rotor 103 are an intake housing 104, a compressor 105, a combustion chamber 110, for example toroidal, in particular an annular combustion chamber, with a number of coaxially arranged burners 107, a turbine 108 and the exhaust housing 109.

The annular combustion chamber 110 communicates with a hot gas duct 111, for example of an annular form. There, the turbine 108 is formed by four successive turbine stages 112, for example.

Each turbine stage 112 is formed, for example, by two blade rings. As seen in the direction of flow of a working medium 113, a row of stationary blades 115 is followed in the hot gas duct 111 by a row 125 formed by moving blades 120.

The stationary blades 130 are in this case fastened to an inner housing 138 of a stator 143, whereas the moving blades 120 of a row 125 are attached to the rotor 103, for example by means of a turbine disk 133.

Coupled to the rotor 103 is a generator or a machine (not represented).

During the operation of the gas turbine 100, air 135 is sucked in by the compressor 105 through the intake housing 104 and compressed. The compressed air provided at the end of the compressor 105 on the turbine side is passed to the burners 107 and mixed there with a fuel. The mixture is then burned in the combustion chamber 110 to form the working medium 113. From there, the working medium 113 flows along the hot gas duct 111 past the stationary blades 130 and the moving blades 120. At the moving blades 120, the working medium 113 expands, transferring momentum, so that the moving blades 120 drive the rotor 103 and the latter drives the machine coupled to it.

The components that are exposed to the hot working medium 113 are subjected to thermal loads during the operation of the gas turbine 100. The stationary blades 130 and moving blades 120 of the first turbine stage 112, as seen in the direction of flow of the working medium 113, are thermally loaded the most, along with the heat shielding elements lining the annular combustion chamber 110.

In order to withstand the temperatures prevailing there, these may be cooled by means of a coolant.

Similarly, substrates of the components may have a directional structure, i.e. they are monocrystalline (SX structure) or only have longitudinally directed grains (DS structure).

Iron-, nickel- or cobalt-based superalloys are used for example as the material for the components, in particular for the turbine blade 120, 130 and components of the combustion chamber 110.

Such superalloys are known, for example, from EP 1 204 776 B1, EP 1 306 454, EP 1 319 729 A1, WO 99/67435 or WO 00/44949.

Similarly, the blades 120, 130 may have coatings against corrosion (MCrAlX; M is at least one element of the group comprising iron (Fe), cobalt (Co) and nickel (Ni), X is an active element and represents yttrium (Y) and/or silicon, scandium (Sc) and/or at least one element of the rare earths, or hafnium). Such alloys are known from EP 0 486 489 B1, EP 0 786 017 B1, EP 0 412 397 B1 or EP 1 306 454 A1.

A thermal barrier coating, which consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

Columnar grains are produced in the thermal barrier coating by suitable coating methods, such as for example electron-beam physical vapor deposition (EB-PVD).

The stationary blade 130 has a stationary blade root (not represented here), facing the inner housing 138 of the turbine 108, and a stationary blade head, at the opposite end from the stationary blade root. The stationary blade head faces the rotor 103 and is fixed to a fastening ring 140 of the stator 143.

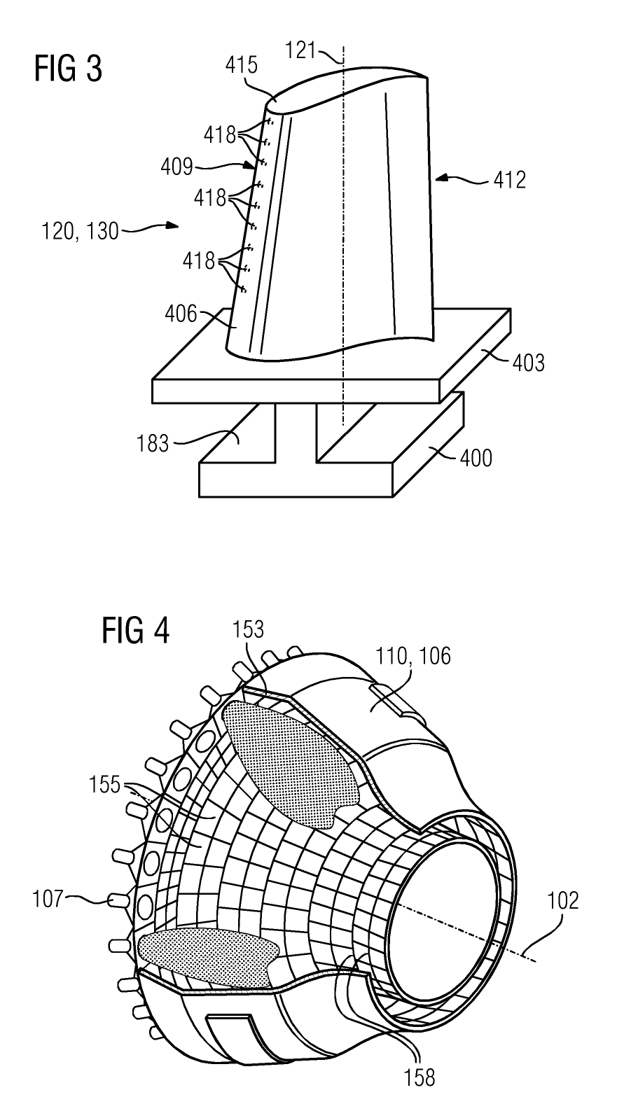

FIG. 3 shows in a perspective view a moving blade 120 or stationary blade 130 of a turbomachine, which extends along a longitudinal axis 121.

The turbomachine may be a gas turbine of an aircraft or of a power plant for generating electricity, a steam turbine or a compressor.

The blade 120, 130 has, following one after the other along the longitudinal axis 121, a fastening region 400, an adjoining blade platform 403 and also a blade airfoil 406 and a blade tip 415.

As a stationary blade 130, the blade 130 may have a further platform at its blade tip 415 (not represented).

In the fastening region 400 there is formed a blade root 183, which serves for the fastening of the moving blades 120, 130 to a shaft or a disk (not represented).

The blade root 183 is designed, for example, as a hammerhead. Other designs as a firtree or dovetail root are possible.

The blade 120, 130 has for a medium which flows past the blade airfoil 406 a leading edge 409 and a trailing edge 412.

In the case of conventional blades 120, 130, solid metallic materials, in particular superalloys, are used for example in all the regions 400, 403, 406 of the blade 120, 130.

Such superalloys are known, for example, from EP 1 204 776 B1, EP 1 306 454, EP 1 319 729 A1, WO 99/67435 or WO 00/44949.

The blade 120, 130 may in this case be produced by a casting method, also by means of directional solidification, by a forging method, by a milling method or combinations of these.

Workpieces with a monocrystalline structure or structures are used as components for machines which are exposed to high mechanical, thermal and/or chemical loads during operation.

The production of monocrystalline workpieces of this type takes place for example by directional solidification from the melt. This involves casting methods in which the liquid metallic alloy solidifies to form the monocrystalline structure, i.e. to form the monocrystalline workpiece, or in a directional manner.

Dendritic crystals are thereby oriented along the thermal flow and form either a columnar grain structure (i.e. grains which extend over the entire length of the workpiece and are commonly referred to here as directionally solidified) or a monocrystalline structure, i.e. the entire workpiece comprises a single crystal. In these methods, the transition to globulitic (polycrystalline) solidification must be avoided, since undirected growth necessarily causes the formation of transversal and longitudinal grain boundaries, which nullify the good properties of the directionally solidified or monocrystalline component.

While reference is being made generally to directionally solidified structures, this is intended to mean both monocrystals, which have no grain boundaries or at most small-angle grain boundaries, and columnar crystal structures, which indeed have grain boundaries extending in the longitudinal direction but no transversal grain boundaries. These second-mentioned crystalline structures are also referred to as directionally solidified structures.

Such methods are known from U.S. Pat. No. 6,024,792 and EP 0 892 090 A1.

Similarly, the blades 120, 130 may have coatings against corrosion or oxidation, for example (MCrAlX; M is at least one element of the group comprising iron (Fe), cobalt (Co) and nickel (Ni), X is an active element and represents yttrium (Y) and/or silicon and/or at least one element of the rare earths, or hafnium (Hf)). Such alloys are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermal grown oxide layer) forms on the MCrAlX layer (as an intermediate layer or as the outermost layer).

The composition of the layer preferably comprises Co-30Ni-28Cr-8Al-0.6Y-0.7Si or Co-28Ni-24Cr-10Al-0.6Y. Apart from these cobalt-based protective coatings, nickel-based protective coatings are also preferably used, such as Ni-10Cr-12Al-0.6Y-3Re or Ni-12Co-21Cr-11Al-0.4Y-2Re or Ni-25Co-17Cr-10Al-0.4Y-1.5Re.

A thermal barrier coating, which is preferably the outermost layer, and consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX. The thermal barrier coating covers the entire MCrAlX layer.

Columnar grains are created in the thermal barrier coating by suitable coating methods, such as for example electron-beam physical vapor deposition (EB-PVD).

Other coating methods are conceivable, for example atmospheric plasma spraying (APS), LPPS, VPS or CVD. The thermal barrier coating may have grains which are porous, are provided with microcracks or are provided with macrocracks for better thermal shock resistance. The thermal barrier coating is therefore preferably more porous than the MCrAlX layer.

Refurbishment means that components 120, 130 may have to be freed of protective layers after use (for example by sandblasting). This is followed by removal of the corrosion and/or oxidation layers or products. If need be, cracks in the component 120, 130 are then also repaired. This is followed by recoating of the component 120, 130 and renewed use of the component 120, 130.

The blade 120, 130 may be hollow or be of a solid form. If the blade 120, 130 is to be cooled, it is hollow and may also have film cooling holes 418 (indicated by dashed lines).

FIG. 4 shows a combustion chamber 110 of a gas turbine. The combustion chamber 110 is designed for example as what is known as an annular combustion chamber, in which a multiplicity of burners 107, which produce flames 156 and are arranged in the circumferential direction around an axis of rotation 102, open out into a common combustion chamber space 154. For this purpose, the combustion chamber 110 is designed as a whole as an annular structure, which is positioned around the axis of rotation 102.

To achieve a comparatively high efficiency, the combustion chamber 110 is designed for a comparatively high temperature of the working medium M of approximately 1000° C. to 1600° C. To permit a comparatively long operating time even with these operating parameters that are unfavorable for the materials, the combustion chamber wall 153 is provided on its side facing the working medium M with an inner lining formed by heat shielding elements 155.

Each heat shielding element 155 of an alloy is provided on the working medium side with a particularly heat-resistant protective layer (MCrAlX layer and/or ceramic coating) or is produced from material that is resistant to high temperature (solid ceramic bricks).

These protective layers may be similar to the turbine blades, meaning for example MCrAlX: M is at least one element of the group comprising iron (Fe), cobalt (Co) and nickel (Ni), X is an active element and represents yttrium (Y) and/or silicon and/or at least one element of the rare earths, or hafnium (Hf). Such alloys are known from EP 0 486 489 B1, EP 0 786 017 B1, EP 0 412 397 B1 or EP 1 306 454 A1.

A thermal barrier coating, which is for example a ceramic thermal barrier coating consists for example of ZrO₂, Y₂O₃—ZrO₂, i.e. is unstabilized, partially stabilized or completely stabilized by yttrium oxide and/or calcium oxide and/or magnesium oxide, may also be present on the MCrAlX.

Columnar grains are produced in the thermal barrier coating by suitable coating methods, such as for example electron-beam physical vapor deposition (EB-PVD).

Other coating methods are conceivable, for example atmospheric plasma spraying (APS), LPPS, VPS or CVD. The thermal barrier coating may have grains which are porous, are provided with microcracks or are provided with macrocracks for better thermal shock resistance.

Refurbishment means that heat shielding elements 155 may have to be freed of protective layers after use (for example by sandblasting). This is followed by removal of the corrosion and/or oxidation layers or products. If need be, cracks in the heat shielding element 155 are then also repaired. This is followed by recoating of the heat shielding elements 155 and renewed use of the heat shielding elements 155.

On account of the high temperatures in the interior of the combustion chamber 110, a cooling system may also be provided for the heat shielding elements 155 or for their holding elements. The heat shielding elements 155 are then for example hollow and, if need be, also have cooling holes (not represented) opening out into the combustion chamber space 154.

A process simulation, in particular of the thickness and/or quality of a layer of a spray coating on the basis of the actual path data recorded and the actual process data recorded, has been described with reference to an exemplary embodiment. As mentioned, this simulation may take place after the coating of a component or during the process with a short time delay.

In the case of the simulation after the coating, a correction coating may be proposed and the (component-) individual coating program required for this (including path data for the robot arm or a CNC machine and including adapted process data) can take place directly after the coating that has already taken place, so that renewed clamping of the component is not required. Furthermore, the simulation after the coating of the component allows an adaptation of all the coating parameters, including path data, for the next component to be coated. In this way, much lower fluctuations in the quality of the layer and the thickness of the layer can be generated.

If the simulation takes place during the spraying process with a short time delay, it is possible as described to have a direct influence on the process data and the path data of the spraying method. For this purpose, a corresponding adaptation of the hardware and the software takes place, in order to make it possible for control programs and/or path data and/or process data to be uploaded and downloaded. In particular in the case of simulation during the process with a short time delay, a visual display of the progress of the process may also take place, in order to provide the operator with useful information concerning possible risks.

Although the present invention has been described with reference to an exemplary embodiment, it goes without saying that this exemplary embodiment merely serves for representing the invention by way of example and that deviations from this exemplary embodiment are possible. For example, the correction data calculation unit and/or the display unit need not necessarily be present. Furthermore, within the scope of the exemplary embodiment, the time-resolved process data are coupled to the time-resolved path data, in order to assign the time-resolved process data to a position and an orientation of the spray nozzle in relation to the component surface by way of the path data. There is however also the possibility of assigning the process data to a position and orientation of the spray nozzle independently of the path data. A device which records the orientation and position of the spray nozzle in relation to the component surface to be coated independently of the path data may be used for example for this purpose. For example, the optical recording of the component and the spray nozzle from various angles together with image analysis software is conceivable. There is also the possibility of recording the path data in this way, so that the path data recording unit need not be connected to the control unit of the spraying device. These examples show that it is possible to deviate from the exemplary embodiment within the scope of the invention. The invention should therefore not be restricted to the refinement that is constituted by the exemplary embodiment, but only be restricted by the appended claims.

1. A coating method for application of a spray coating to a component surface comprising the steps of:
coating the component surface by a spraying process, by moving a spray nozzle along a designated path in relation to the component surface during the coating;
recording in a time-resolved form path data of the movement of the spray nozzle in relation to the component surface;
recording in a time-resolved form process data of the coating process;
simulating the spraying process of the nozzle based on the time-resolved path data recorded, the time-resolved process data recorded and the geometry of the component surface to be coated, in order to obtain a simulated coating; and
calculating a deviation of the simulated coating from a desired coating.

2. The coating method as claimed in claim 1, further comprising:
correcting the coating on the component surface if the calculation of the deviation produces a deviation of the simulated coating from the desired coating that exceeds a permissible deviation.

3. The coating method as claimed in claim 2, wherein the correcting of the coating is performed after the spraying process is ended and for which the path data and the process data have been recorded in a time-resolved form;
the correcting of the coating comprises applying a correction coating by a further spraying process using a spray nozzle;
determining the path data and the process data for the further spraying process from the deviation of the simulated coating, obtained with the simulated spraying process, from the desired coating.

4. The coating method as claimed in claim 3, wherein the simulation of the spraying process is based on the path data recorded in a time-resolved form, the process data recorded in a time-resolved form and the geometry of the surface to be coated of the component after the spraying process is ended for which the path data and the process data are recorded in a time-resolved form.

5. The coating method as claimed in claim 1, further comprising performing the simulation of the spraying process while performing the spraying process in which the path data and the process data are recorded in a time-resolved form.

6. The coating method as claimed in claim 5, further comprising:
correcting the path data and/or the process data of the spraying process by using correction data, and determining the correction data from the deviation of the simulated coating, obtained with the simulated spraying process, from the desired coating.

7. The coating method as claimed in claim 6, further comprising determining the correction data within a time period in the range of less than 5 seconds.

8. The coating method as claimed in claim 1, further comprising visually displaying the deviation of the simulated coating, obtained with the simulated spraying process, from the desired coating.

9. The coating method as claimed in claim 8, further comprising generating the graphic display within a time period in a range of less than 5 seconds.

10. The coating method as claimed in claim 1, further comprising:
updating the path data and/or the process data for a next spraying process for a component with a same geometry of the surface to be coated, determining the updated path data and/or the updated process data from the deviation of the simulated coating, obtained with the simulated spraying process, from the desired coating.

11. The coating method as claimed in claim 1, wherein the process data are recorded in a time-resolved form in relation to the component surface to be coated.

12. The coating method as claimed in claim 1, wherein the process data recorded are coupled to the path data recorded.

13. A monitoring device for monitoring and controlling an automated application of a spray coating to a component surface comprising:
a spraying device including a spray nozzle, movable along a specific path in relation to the component surface during the spraying process; and
a control unit configured for controlling the spraying process, and comprising:
an input interface for inputting geometry data representative of the geometry of the component surface to be coated;
a path data recording device for time-resolved recording of path data of the spray nozzle in relation to the component surface to be coated;
a process data recording device for time-resolved recording of process data of the coating process using the spray nozzle;
a simulation unit which is connected to the input interface for receiving the geometry data, which is connected to the path data recording device, for receiving the path data recorded in a time-resolved form and which is connected to the process data recording device for receiving the process data recorded in a time-resolved form, the simulation unit is configured for simulating the application of the spray coating to the component surface based on the path data recorded in a time-resolved form, the process data recorded in a time-resolved form and the geometry of the component surface and the simulation unit being ready for outputting simulation data of a simulated coating; and
a deviation calculation unit, connected to the simulation unit, for receiving the simulation data, and for calculating a deviation of the simulated coating from the desired coating.

14. The monitoring device as claimed in claim 13, further comprising a correction data calculation unit, connected to the deviation calculation unit and configured for receiving the calculated deviation and for calculating correction data for correcting the coating on the component surface when the calculated deviation exceeds a permissible deviation.

15. The monitoring device as claimed in claim 13, further comprising a display unit connected to the deviation calculation unit for receiving the calculated deviation and generating a display signal for visual display of the deviation.

16. In combination, a coating device with a spraying device comprising:
a spray nozzle movable along a specific path in relation to a component surface during a spraying process for spraying a component;
a control unit configured for controlling the spraying process; and
a monitoring device as claimed in claim 13.

17. The combination as claimed in claim 16, further comprising the control unit of the spraying device is connected to the correction data calculation unit for receiving the correction data from the correction data calculation unit.

18. The coating method as claimed in claim 1, wherein the component to be sprayed and/or monitored is a turbine component.

19. The monitoring device as claimed in claim 13, wherein the component to be sprayed and/or monitored is a turbine component.
